(19) United States
(12) Patent Application Publication
(10) Pub. No.: US 2019/0254268 A1
(43) Pub. Date: Aug. 22, 2019

(54) FISHING LURE QUICK RELEASE

(71) Applicant: Wayne Parker, Salem, OR (US)

(72) Inventor: Wayne Parker, Salem, OR (US)

(21) Appl. No.: 15/898,514

(22) Filed: Feb. 17, 2018

(51) Int. Cl. A01K 91/04; A01K 85/16

(52) U.S. Cl. CPC A01K 91/04; A01K 85/16

(57) ABSTRACT

A quick release fishing trolling flasher lure having a front end and back end, with a receiver affixed to the back end and secured head affixed to the front end and one or more hooks connected to the secured head. In operation, the added tension of a fish on a hook causes the receiver and the secured head to separate releasing the tension along the line of the flasher, reducing the movement of the flasher and related interference with keeping a fish on the line.

### CROSS-REFERENCE TO RELATED APPLICATION

This invention claims the benefit of the prior filed Provisional Application, No. 62/600,276, filed Feb. 17, 2017, the content of which is incorporated herein.

### BACKGROUND OF THE INVENTION

### 1. Field of the Invention

The present invention relates to fishing lures commonly called flashers, and more particularly to a new and improved quick release for a trolling type flasher lure that permits a higher catch rate by reducing interference of the flasher movement once a fish has been caught on the hook.

The field of fishing lures is crowded with countless creative solutions to the numerous problems fishermen have encountered. The general nature of fishing with lures is to create an attractor for fish, often through a combination of visual and auditory and sometimes electrical stimuli. A secondary aspect of lure design is to mimic prey such that once the lure is noticed it will be recognized as a food source. A common type of lure is known as a flasher, which is generally a large plate with offset ends or fins such that when pulled through the water the plate oscillates or moves in a dynamic pattern, often reflecting light. Illustrative of the flashing lures is U.S. Pat. No. 6,112,450 to Studanski, issued Sep. 5, 2000, which discloses a lure that provides an accentuated zigzag or oscillating movement when the device is pulled through the water. U.S. Pat. No. 6,115,957 to Bocach, issued Sep. 12, 2000, teaches a fishing lure including a body having a wing member to provide dynamic movement as the lure is pulled through the water. U.S. Pat. No. 6,493,984 to Bechhold, issued Sep. 25, 2001, discloses a trolling flasher with a body and fin design that induces a rotational motion and whipping effect even at slow trolling speeds. Another illustrative patent is U.S. Pat. No. 6,643,975 to Edwards, issued Nov. 12, 2002. The Edwards patent discloses a triangular body with displaced edges to induce an oscillating and rotational motion, together with a sound generating plastic film.

Generally the technology has focused on a means of using the force of pulling a lure through the water to translate some of that force into rotational, cylindrical, or even random movements, together with varying degrees of vibration or sound and moving surfaces for reflecting light, often augmented by the use of holographic and reflective materials. However the lure may use this force of being pulled through the water, it also generally creates drag as the lure is pulled though the water with increasing and variable resistance in the generation of movement that often leads to varying degrees of tension on the line. A larger the flasher with more dynamic movement will result in greater fish attraction, but at the same time will also result in greater dynamics of line tension and even the directional tension as the flasher moves through the water.

### 2. Problem with the Prior Art

As the lures spin and weave their way through the water varying line tensions, and drag are created and the vector of the line tension changes as intermittent between the fisherman or anchor point and the hook the lure is moving in varied directions. While this movement is useful in attracting fish, once a fish is caught on the hook the additional drag and varying line tensions and vectors become problematic as the movement of the lure through the water may prevent a fisherman from keeping a hook set and landing a caught fish as such movement can assist the fish in freeing itself from the hook. What is missing and needed is a means of reducing or eliminating the movement and drag of a flasher lure once the fish is on the hook, thereby allowing the fisherman to maintain constant tension on the line without the added drag and movements of the flasher lure.

The present inventor herein discloses a novel and useful device for reducing the flasher lure generated tension and movement by partially releasing the lure once a fish is on the line, increasing the rate of success of landing a fish.

### SUMMARY OF THE INVENTION

The fishing lure quick release of the present invention provides a means to apply force to the lure to permit traditional motion and vibration to be generated through resistance as the lure is pulled through water, yet reduces or eliminates the additional drag and movement of the lure once a fish has been caught on the hook.

A classic flasher type lure will be largely planar with a forward end and a back end and one or more bends or fins to increase the movement of the flasher as it is pulled through the water. The bends and fins of a flasher are generally designed to maximize movement when there is tension placed linearly along the axis of the flasher. There is a forward connection and a rear connection and in conventional use the forward connection is affixed to the line held by the fisherman and the rear connection is affixed to one or more hooks, hooks on a line with or without bait. In conventional use the tension of the fishing line is continuous from the line held by the fisherman to the forward end of the flasher, then axially transiting the flasher on to the hooks with a line of tension that transits the flasher from the forward end to the rear end.

The disclosed quick release comprises a receiver and a secured head with the secured head affixed to the front end of a flasher lure by a slack line and the receiver attached to the back end. One or more hooks, or a line with hooks are then affixed to the secured head, but not the flasher such that the line of tension is in line with the body of the flasher when the receiver end is connected to the secured head, but when separated the line of tension bypasses the flasher.

### BRIEF DESCRIPTION OF THE DRAWINGS

FIG. 1 is a perspective view of the quick release fishing lure used with a trolling flasher type lure with the receiver end and a secured head connected;

FIG. 2 is a perspective view of the quick release fishing lure used with a trolling flasher type lure with the receiver end and a secured head separated;

FIG. 3 is a detailed view of the receiver and a secured head separated showing the slack line;

FIG. 4a is a detailed view of the preferred embodiment of the receiver end;

FIG. 4b is a detailed view of the preferred embodiment of the receiver end and secured head;

FIG. 4c is a plan view of the preferred embodiment of the receiver end;

FIG. 4d is a cross sectional view of the preferred embodiment of the receiver end of FIG. 4c along line A-A;

FIG. 4e is am axial plan view of the preferred embodiment of the receiver end;

FIG. 4f is an opposite side plan view from FIG. 4c of the preferred embodiment of the receiver end;

### DETAILED DESCRIPTION OF THE PREFERRED EMBODIMENTS

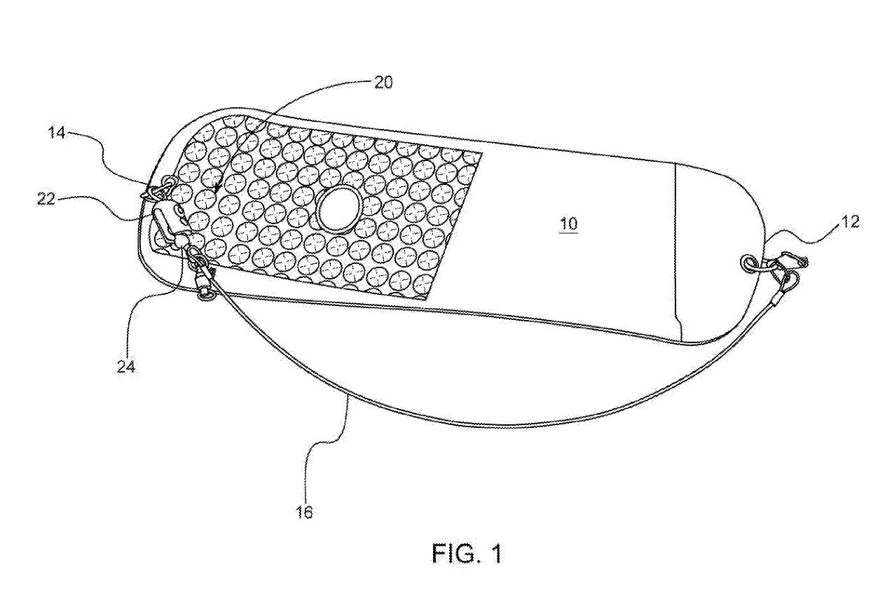

According to the present invention there is disclosed a quick release for a flasher type trolling fishing lure. As shown in FIG. 1, the body of the flasher is generally denominated 10, having a geometry adapted to produce a range of motion during trolling. The lure comprises a front end 12, a back, distal, or butt end 14, a substantially planar body 10. At each end there is an eyelet 12a, 14a. The front-end eyelet 12a is for connection to the fishing line or fisherman and a slack line 16. The back end of the flasher has affixed the receiver 22. The slack line 16 has the secured head 22 on the distal end of the slack line from the portion connected to the front end and the secured head 22 is connected to the butt end 14 of the flasher by the receiver 22.

In operation the line of tension from the fishing line 13 to the point of affixing the hook 18 is along the flasher 10 with the slack line 16 slightly longer than the flasher 10. In this state the receiver 22 is connected to the secured head 24 located on the rear end eyelet 14a.

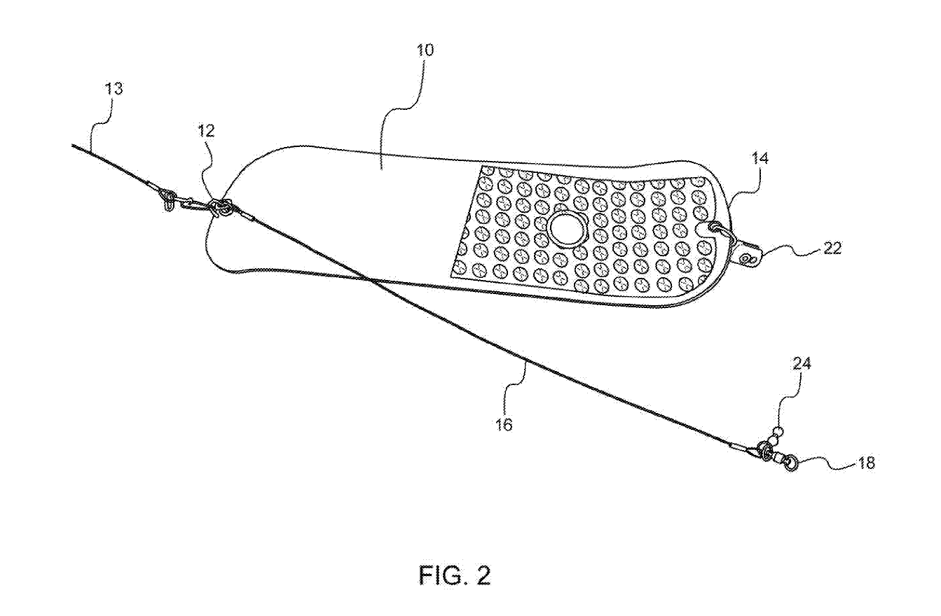

When there is sufficient additional tension added to the hook point 18, the secured head 24 separates from the receiver end 22 and the tension line from the hook with a fish is transferred to the slack line 16 such that there is no tension on the flasher 10 as shown in FIG. 2. This greatly reduces the movement of the flasher 10, and permits the fisherman to maintain constant tension between the fishing line 13 and the hook point 18 preventing the flasher from dislodging the fish. This leaves the secured head 22 in a free state, and allows one or more hooks affixed to the end of the slack line at the hook point 18 to transmit any load directly to the fishing line 13.

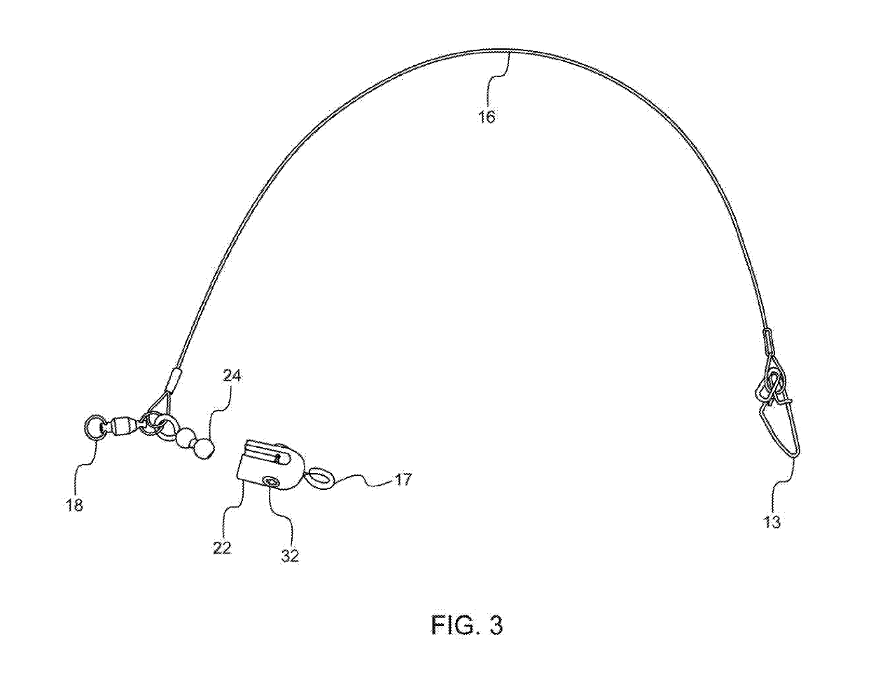

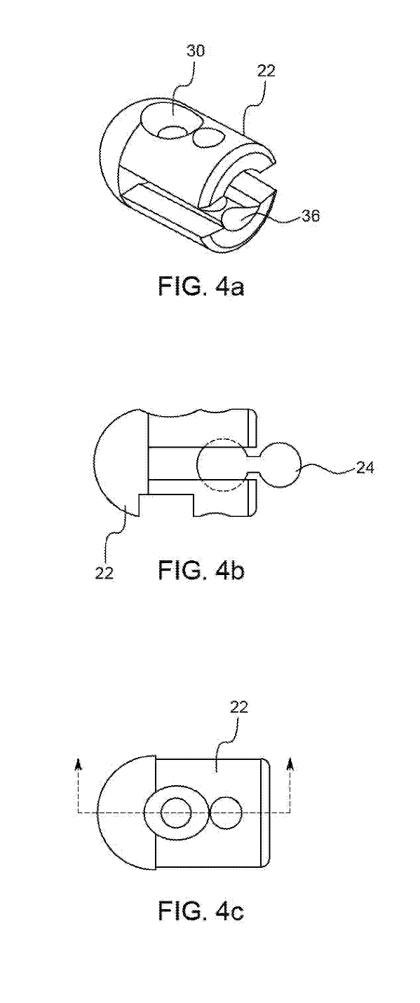

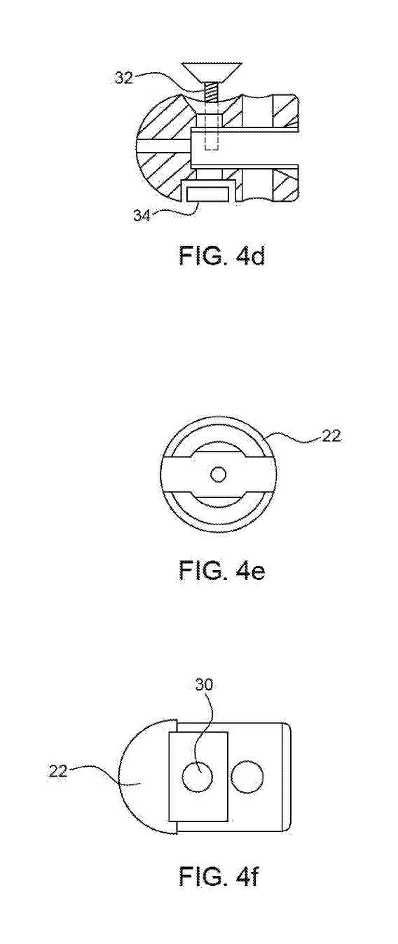

Disclosed in the preferred embodiment as shown in FIG. 3 is ball and socket receiver end 22 with a means for affixing the receiver to a flasher 17 and secured head 24, which may be further modified with tensioner such as an adjustment screw 32 and receiver nut 34 (FIG. 4.) to increase the socket 36 tension on the receiver 22. A point for affixing a fishing line to a fisherman is shown at 13 and the attachment point for one or more hooks or a hook point is shown at 18.

As depicted in FIGS. 4a-4f, details of the receiver and secured head are shown with a recess 30 for receiving a tensioner screw 32, and a recess socket 36 for receiving the ball of the secured head 24. The tensioner screw 32 may be threaded directly to the receiver 22 or secured by a threaded nut 34 to permit adjustments of the tension applied by the receiver to the secured head.

The quick release components 22, 24 may be made of polymer or plastic of a suitable hardness, metal, or ferromagnetic materials. In the use of ferromagnetic materials there may be the added benefit of a magnetic coupling between the secured head 24 and receiver 22. Such ferromagnetic materials may also provide for additional attractiveness to fish as it is known some fish detect magnetic fields in their location of prey. The slack line 16 may be of any suitable material, including traditional monofilament, braided line, metal cable, or even semi-rigid wire as may be desired.

While particular embodiments of the present invention have been shown and described, it will be obvious to those skilled in the art that changes and modifications may be made without departing from this invention in its broader aspects. To aid in the understanding and comprehension of the invention the appended claims are provided. It is disclosed the actual invention claimed is not limited to such claims, but intended to cover all changes and modifications as fall within the spirit and scope of the claims.

What is claimed as invention is:

1. A quick release for a fishing lure for use in trolling, comprising:
a flasher type lure with a substantially planar body having a front end, a back end, and a longitudinal axis, with at least one eyelet at said back end for connection to a receiver; at least one eyelet at said front end for connection to a fishing line; a secured head attached by a slack line to said front eyelet; and receiver end secured to said back end eyelet wherein said secured head and said receiver may be separably connected.

2. The quick release for a fishing lure of claim 1, wherein said receiver is of a socket type and said secured head is of a ball type.

3. The quick release for a fishing lure of claim 1, wherein said receiver contains a tension adjustment means.

4. The quick release for a fishing lure of claim 1 wherein said receiver and secured head are comprised of ferromagnetic materials.

5. A quick release for a fishing lure for use in trolling, comprising:
a secured head and a slack line for attachment to a forward end of a flasher type lure and a receiver for attachment to a back end of a flasher type lure wherein said secured head and said receiver may be separably connected.

6. The quick release for a fishing lure of claim 5, wherein said receiver is of a socket type and said secured head is of a ball type.

7. The quick release for a fishing lure of claim 5, wherein said receiver contains a tension adjustment means.

8. The quick release for a fishing lure of claim 5 wherein said receiver and secured head are comprised of ferromagnetic materials.
